(19) United States
(12) Patent Application Publication
(10) Pub. No.: US 2012/0167703 A1
(43) Pub. Date: Jul. 5, 2012

(54) Roller element for ball screw device

(75) Inventor: Yushan Lee, Taichung (TW)

(73) Assignee: Hiwin Technology Corp.

(21) Appl. No.: 12/930,134

(22) Filed: Dec. 29, 2010

(51) Int. Cl. F16H 25/22

(52) U.S. Cl. 74/424.92

(57) ABSTRACT

A motion guide device or ball screw device includes a ball nut attached onto a shaft and having helical grooves for forming a ball guiding raceway between the ball nut and the elongated shaft, and a number of roller bearing elements received and engaged with the roller guiding raceway of the ball nut and the elongated shaft, and the roller bearing elements each include two or more bearing members disposed side by side relative to each other, one of the bearing members includes a coupling member or shaft for engaging with the other bearing member and for pivotally coupling the bearing members together, the bearing members include one or more depressions for receiving a lubricating oil or the like.

### BACKGROUND OF THE INVENTION

1. Field of the Invention

The present invention relates to a ball screw device, and more particularly to a ball screw device including a screw shaft and a ball nut movable relative to each other, and a number of improved roller elements attached between the screw shaft and the ball nut for suitably circulating between the two movable members and for suitably bearing and guiding the movable members to move relative to each other.

2. Description of the Prior Art

Typical motion guide apparatuses, such as the linear motion guide apparatuses or ball screw devices comprise two movable members rotatable or movable relative to each other, and a number of ball or roller bearing elements disposed between the two movable members for facilitating the sliding movement between the two movable members.

For example, U.S. Pat. No. 6,109,789 to Chen, U.S. Pat. No. 6,390,678 to Shirai, U.S. Pat. No. 6,419,069 to Teramachi, U.S. Pat. No. 6,481,305 to Nishimura et al., U.S. Pat. No. 6,733,179 to Michioka et al., and U.S. Pat. No. 7,044,641 to Scotte et al. disclose several of the typical linear motion guide apparatuses each comprising two movable members movable relative to each other, and a number of ball or roller bearing elements disposed between the two movable members for facilitating the sliding movement between the two movable members.

Normally, the roller bearing elements each include a cylindrical structure having the same outer diameter through out the length thereof; i.e., the roller bearing elements each include a uniform outer diameter through out the length thereof for suitably engaging between the two movable members.

However, the two end portions of the roller bearing elements may be subjected with different loads, or the movable members may apply different loads onto the two end portions of the roller bearing elements, such that the rubbing or wearing conditions of the two end portions of the roller bearing elements may be different from each other, and such that one of the two end portions of the roller bearing elements may be worn out first then the other end portions of the roller bearing elements, and such that the movement between the two movable members may be affected of interfered by the roller bearing elements after use.

The present invention has arisen to mitigate and/or obviate the afore-described disadvantages of the conventional roller bearing elements for the linear motion guide apparatuses or the ball screw devices.

### SUMMARY OF THE INVENTION

The primary objective of the present invention is to provide a ball screw device including a screw shaft and a ball nut movable relative to each other, and a number of improved roller elements attached between the screw shaft and the ball nut for suitably circulating between the two movable members and for suitably bearing and guiding the movable members to move relative to each other.

In accordance with one aspect of the invention, there is provided a ball screw device comprising an elongated shaft including a helical groove formed on an outer peripheral portion thereof, a ball nut movably attached onto the elongated shaft, and including a bore formed therein for receiving the elongated shaft, and including a helical groove formed therein for forming a roller guiding passage or raceway between the ball nut and the elongated shaft, and a number of roller bearing elements received and engaged with the roller guiding raceway of the ball nut and the elongated shaft, in which the roller bearing elements each include a first bearing member and a second bearing member disposed side by side relative to each other.

The second bearing member includes a coupling member for engaging with the first bearing member and for pivotally coupling the first and the second bearing members together. For example, the first bearing member includes a cavity formed therein, and the coupling member of the second bearing member is a shaft for engaging with the cavity of the first bearing member and for pivotally coupling the first and the second bearing members together.

The cavity of the first bearing member may be selected from a cylindrical or cone-shaped structure, and the shaft of the second bearing member may also be selected from a cylindrical or cone-shaped structure for engaging with the cylindrical or cone-shaped cavity of the first bearing member and for pivotally coupling the bearing members together.

The first and the second bearing members each include at least one depression formed therein for receiving or engaging with the lubricating oil or the like which may be used to lubricate the bearing members and/or the ball nut and the elongated shaft. The first and the second bearing members each include a cylindrical outer peripheral surface for selectively engaging with the elongated shaft and the ball nut.

The first and the second bearing members each include an outer surface for selectively engaging with the elongated shaft and the ball nut, and each include an inner surface, the inner surfaces of the first and the second bearing members are contacted with each other.

The first and the second bearing members each include an outer diameter preferably equal to each other, or the outer diameters of the first and the second bearing members may be different from each other. The roller bearing elements each may further include a third bearing member disposed or coupled between the first and the second bearing members.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial cross sectional view of a ball screw device in accordance with the present invention;

FIG. 2 is an enlarged partial cross sectional view of the ball screw device;

FIG. 3 is a perspective view of illustrating one of the roller elements of the ball screw device;

FIG. 4 is a partial exploded view illustrating the roller element of the ball screw device;

FIG. 5 is another partial exploded view illustrating the other arrangement of the roller element of the ball screw device;

FIG. 6 is a further partial exploded view illustrating the further arrangement of the roller element of the ball screw device;

FIG. 7 is a still further partial exploded view illustrating the still further arrangement of the roller element of the ball screw device; and

FIG. 8 is a further partial perspective view similar to FIG. 3, illustrating the arrangement of the roller element as shown in FIG. 7.

### DETAILED DESCRIPTION OF THE PREFERRED EMBODIMENT

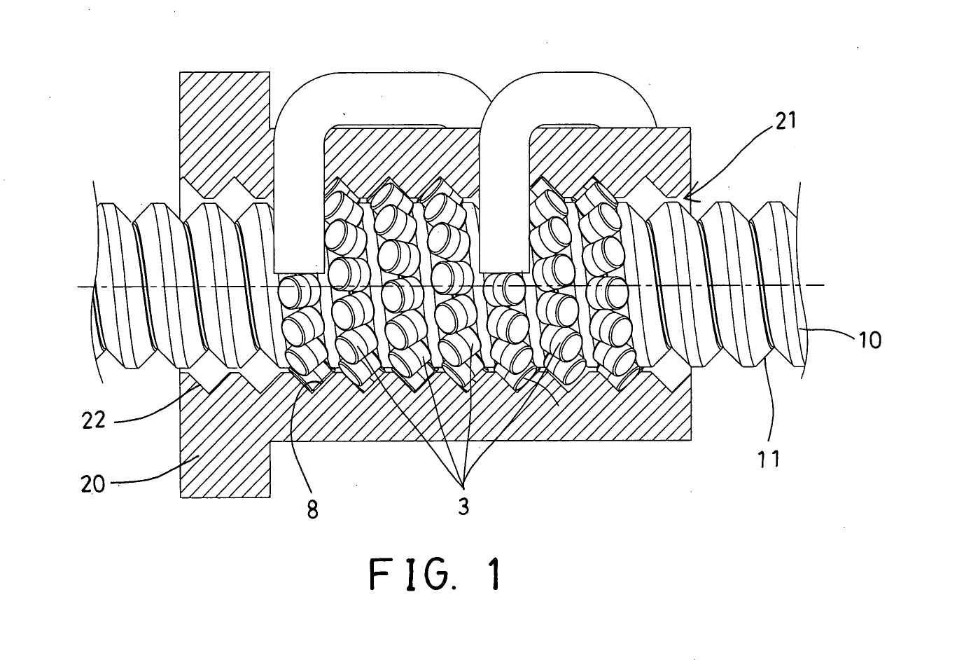

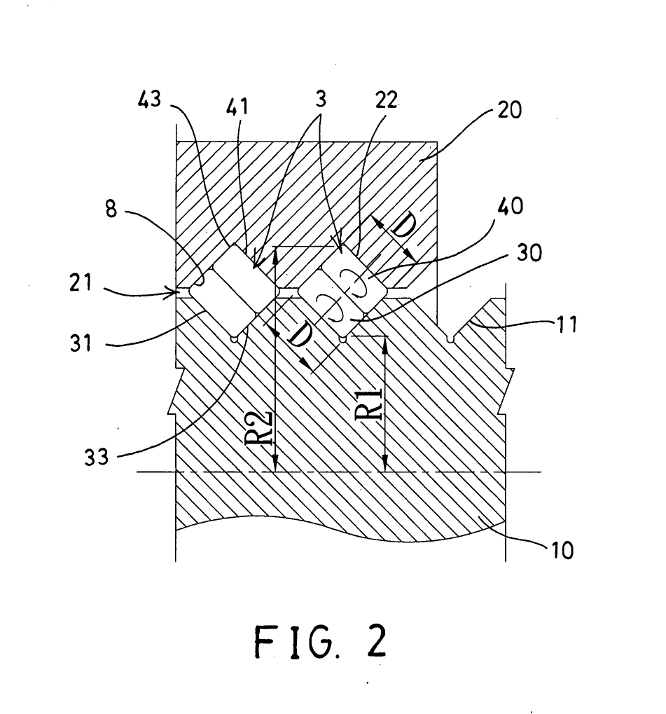

Referring to the drawings, and initially to FIGS. 1-2, a ball screw device in accordance with the present invention comprises an elongated bolt or screw shaft 10 including a number of helical threaded portions or grooves 11 formed on the outer peripheral portion thereof, or formed in the outer peripheral surface thereof, and a movable member, such as a ball nut 20 including a screw hole or bore 21 formed therein for slidably and/or rotatably receiving or engaging with the elongated screw shaft 10, and the screw hole or bore 21 of the ball nut 20 is formed or defined by a number of helical threaded portions or grooves 22 for threading or engaging or aligning with the helical threaded portions or grooves 11 of the screw shaft 10, and for forming one or more multiple-turn, helical ball guiding passages or raceways 8 between the screw shaft 10 and the ball nut 20.

A number of roller bearing elements 3 are slidably and/or rotatably received or engaged within the multiple-turn, helical guiding passages or raceways 8 of the ball screw device and contacted or engaged between the screw shaft 10 and the ball nut 20 for facilitating the sliding and/or rotational movement between the two movable members 10, 20 or between the screw shaft 10 and the ball nut 20. The above-described structure including the two movable members 10, 20 or the screw shaft 10 and the ball nut 20 is typical and will not be described in further details. The roller bearing elements 3 may also be slidably and/or rotatably received or engaged between the two movable members of the typical linear motion guide apparatuses.

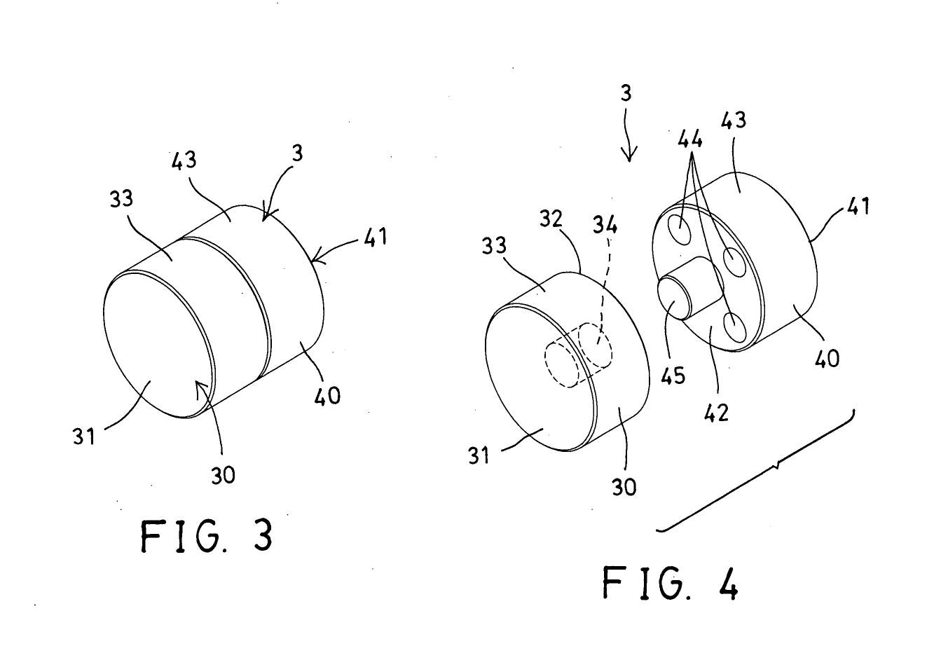

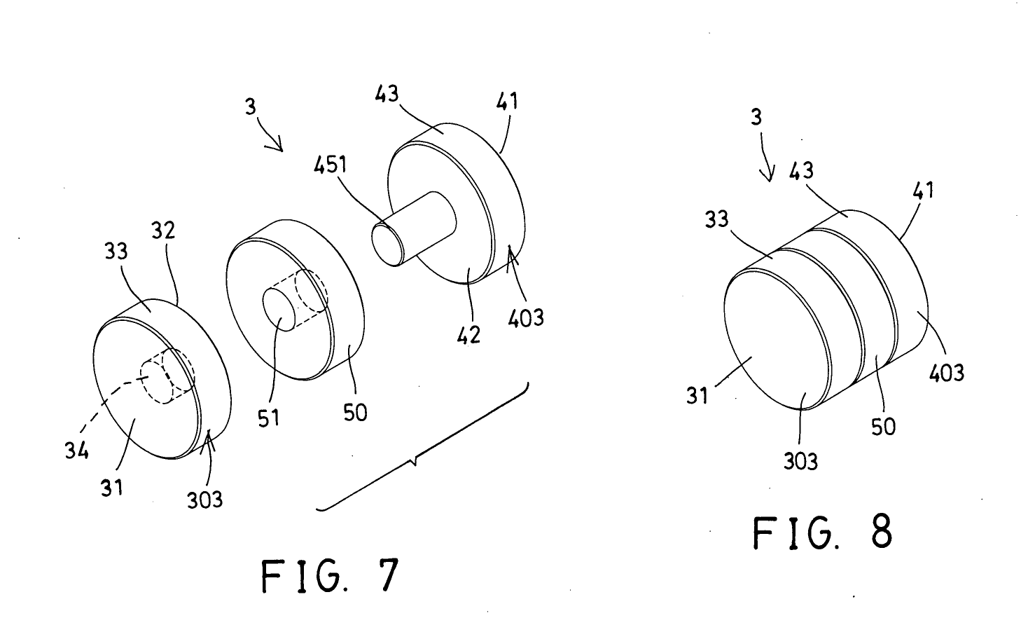

The roller bearing elements 3 each include two or more bearing members 30, 40 contacted or engaged between the screw shaft 10 and the ball nut 20. For example, as shown in FIGS. 1-6, the roller bearing elements 3 each may include two bearing members 30, 40; 301, 401; or 302, 402, or each may include three bearing members 303, 403, 50 as shown in FIGS. 7-8, slidably and/or rotatably received or engaged within the multiple-turn, helical guiding passages or raceways 8 of the ball screw device. As shown in FIGS. 2-4, the bearing members 30, 40 each include a first or outer planar surface 31, 41 for engaging with the screw shaft 10 or the ball nut 20; and each include a second or inner planar surface 32, 42 that is located opposite to and parallel to the first or outer planar surface 31, 41 thereof respectively.

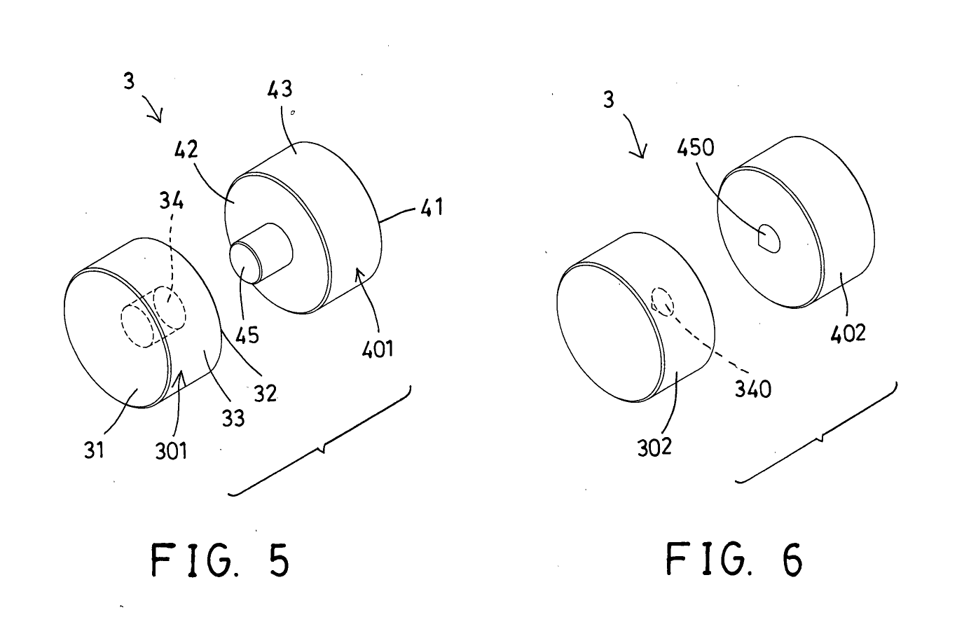

The second or inner planar surfaces 32, 42 of the bearing members 30, 40 are contacted or engaged with each other, or the bearing members 30, 40 are disposed side by side relative to each other, and the bearing members 30, 40 each further include a cylindrical outer peripheral surface 33, 43 also for selectively engaging with the screw shaft 10 or the ball nut 20. It is preferable, but not necessarily that the bearing members 30, 40 include an outer diameter “D” (FIG. 2) equal to each other; i.e., the bearing members 30, 40 may selectively include an outer diameter slightly different from each other. The bearing members 30, 40 each may further include one or more depressions 44 formed therein, such as formed in the second or inner planar surfaces 32, 42 thereof for receiving or engaging with the lubricating oil (not shown) or the like. Alternatively, as shown in FIG. 5, the bearing members 301, 401 may include no depressions formed therein.

The first bearing member 30 includes a cavity 34 formed therein, such as formed in the second or inner planar surface 32 thereof, and the second bearing member 40 includes a coupling member 45, such as a spindle or shaft 45 extended outwardly therefrom, such as extended from the second or inner planar surface 42 thereof for selectively engaging with the cavity 34 of the first bearing member 30 and for pivotally or rotatably engaging or securing or coupling or retaining the bearing members 30, 40 together. The cavity 34 of the first bearing member 30 and the shaft 45 of the second bearing member 40 may include a cylindrical structure (FIGS. 4, 5). Alternatively, as shown in FIG. 6, the cavity 340 of the first bearing member 302 and the shaft 450 of the second bearing member 402 may include a frustum or cone-shaped structure.

In operation, as shown in FIG. 2, the bearing members 30, 40 of the roller bearing elements 3 may be suitably and slidably and/or rotatably received or engaged between the screw shaft 10 or the ball nut 20 and within the multiple-turn, helical guiding passages or raceways 8 of the ball screw device. The radius “R1” of the dedendum of the screw shaft 10 is smaller than the radius “R2” of the dedendum of the ball nut 20, such that the second bearing member 40 may have a greater moving stroke or a greater moving or rotational speed than that of the first bearing member 30, and such that the bearing members 30, 40 of the roller bearing elements 3 may be moved or rotated in different moving or rotational speed from each other. The bearing members 30, 40 of the roller bearing elements 3 may be suitably and easily and quickly manufactured in mass production.

Alternatively, as shown in FIGS. 7 and 8, the roller bearing elements 3 each may further include a third or middle or intermediate bearing member 50 disposed or attached or mounted or coupled between the first bearing member 303 and the second bearing member 403, and the first bearing member 303 may also include a cavity 34 formed therein, such as formed in the second or inner planar surface 32 thereof, and the second bearing member 403 may also include a spindle or shaft 451 extended outwardly therefrom, such as extended from the second or inner planar surface 42 thereof for selectively engaging with the cavity 34 of the first bearing member 303, and the third or middle or intermediate bearing member 50 includes a bore 51 formed in the center portion thereof for receiving or engaging with the shaft 451 which may couple or retain the bearing members 303, 403, 50 together.

Accordingly, the ball screw device in accordance with the present invention includes a screw shaft and a ball nut movable relative to each other, and a number of improved roller elements attached between the screw shaft and the ball nut for suitably circulating between the two movable members and for suitably bearing and guiding the movable members to move relative to each other.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A ball screw device comprising:
an elongated shaft including a helical groove formed on an outer peripheral portion thereof,
a ball nut movably attached onto said elongated shaft, and including a bore formed therein for receiving said elongated shaft, and including a helical groove formed therein for forming a roller guiding raceway between said ball nut and said elongated shaft, and
a plurality of roller bearing elements received and engaged with said roller guiding raceway of said ball nut and said elongated shaft, and
wherein said roller bearing elements each include a first bearing member and a second bearing member disposed side by side relative to each other.

2. The ball screw device as claimed in claim 1, wherein said second bearing member includes a coupling member for engaging with said first bearing member and for pivotally coupling said first and said second bearing members together.

3. The ball screw device as claimed in claim 2, wherein said first bearing member includes a cavity formed therein, and said coupling member of said second bearing member is a shaft for engaging with said cavity of said first bearing member.

4. The ball screw device as claimed in claim 3, wherein said cavity of said first bearing member is cylindrical, and said shaft of said second bearing member is cylindrical for engaging with said cylindrical cavity of said first bearing member.

5. The ball screw device as claimed in claim 3, wherein said cavity of said first bearing member is cone-shaped, and said shaft of said second bearing member is cone-shaped for engaging with said cone-shaped cavity of said first bearing member.

6. The ball screw device as claimed in claim 1, wherein said first and said second bearing members each include at least one depression formed therein.

7. The ball screw device as claimed in claim 1, wherein said first and said second bearing members each include a cylindrical outer peripheral surface for selectively engaging with said elongated shaft and said ball nut.

8. The ball screw device as claimed in claim 1, wherein said first and said second bearing members each include an outer surface for selectively engaging with said elongated shaft and said ball nut, and each include an inner surface, said inner surfaces of said first and said second bearing members are contacted with each other.

9. The ball screw device as claimed in claim 1, wherein said first and said second bearing members each include an outer diameter equal to each other.

10. The ball screw device as claimed in claim 1, wherein said roller bearing elements each further include a third bearing member disposed between said first and said second bearing members.
